(19) United States
(12) Patent Application Publication
(10) Pub. No.: US 2015/0310564 A1
(43) Pub. Date: Oct. 29, 2015

(54) SYSTEMS AND METHODS FOR GEO-CODED FINANCIAL ACCOUNT STATEMENT VISUALIZATION

(71) Applicant: Capital One Financial Corporation, McLean, VA (US)

(72) Inventor: Terren J. PETERSON, Richmond, VA (US)

(21) Appl. No.: 14/793,809

(22) Filed: Jul. 8, 2015

Related U.S. Application Data
(63) Continuation of application No. 11/698,859, filed on Jan. 29, 2007.

(51) Int. Cl. G06Q 40/00; G06F 17/30; G06F 3/0484; H04L 29/08; G06F 3/0482

(52) U.S. Cl. CPC G06Q 40/12; H04L 67/10; G06F 3/0482; G06F 3/04842; G06F 17/30241

(57) ABSTRACT

Systems and methods for geo-coded financial statement visualization are disclosed. Financial account transaction history, such as credit card accounts, are geo-coded based on the merchant identification information. A map-based visualization is generated that includes the map point representative of merchant locations associated with the transactions. Additional detailed merchant information may be encoded into each map point such as address, telephone number, hours of operation, and other information not typically available from the transaction processing network.

### FIELD OF THE INVENTION

The present invention relates generally to software-based financial account tools and more specifically to systems and methods for geo-coded financial account statement visualization using software-based techniques.

### BACKGROUND OF THE INVENTION

Online account interfaces have become standard for banks and other financial institutions. Through online portals, these institutions can provide more and better data to their customers including statements, transactional history, automated services (balance transfers, bill payments, etc.) and/or automated front ends to manual services (e.g., credit limit increases, new check requests, etc.). It is usually much cheaper to provide these services via an online portal such as an Internet website than to handle these non-revenue generating interactions by telephone or in person. Also, by making these service available on line, customers may utilize them any time of day or day of the week.

As consumers have become more dependent on the Internet and as email continues to replace traditional mail as the preferred method of receiving statements and other information, banks, credit card companies, have invested heavily in automated bill payment and account services interfaces. These systems are used to provides competitive advantage in the market place. Most online banking systems share much common functionality. That is, consumers can view their current and past statements as electronic documents that list the transactions with a running balance listed on one side, in a manner that mimics the paper account statements. Thus, given this constraint, it is difficult for the “look and feel” of one institution's portal to differ significantly from another. Accordingly, there exists a need for an account visualization system that provides a richer and more unique experience for the user that will enhance customer loyalty and provide market differentiation.

### SUMMARY OF THE INVENTION

In view of the above noted shortcomings of existing system, various embodiments of the invention may provide a method of preparing a transaction visualization associated with at least one financial account. The method according to this embodiment may comprise accessing a record of transactions associated with the at least one financial account for a particular time period, for each transaction, obtaining identification information associated with a location of the transaction, overlaying at least a portion of the identification information on a geographic map of a region to form a geo-coded transaction record, and outputting the geo-coded transaction record to a user over a network.

Another exemplary embodiment may provide a financial account transaction visualization system. The system according to this embodiment may comprise a customer account module storing account information corresponding to a plurality of customers, a transaction module storing financial transactions associated with the customer accounts, a geo-coding module that, for each customer account, codes each transaction to a set of geographical coordinates, and a visualization module that outputs a geographical-based visualization of a transaction history of a customer's account to an interface program of a remote customer based on input from the transaction module and the geo-coding module.

An additional exemplary embodiment may provide a network-based financial account visualization system. The system according to this embodiment may comprise a first interface that accesses a database of transactional history for a plurality of customer financial accounts, a second interface that accesses a database of merchant identification information that stores merchant identification information of merchants associated with transactions in the transactional history, a geographic mapping module that geo-codes transactions accessed by the first interface to merchant identification information in map-based visualizations, and an output module that outputs map-based visualizations over a communications network.

These and other embodiments and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is a high level block diagram illustrating an exemplary network-based system for geo-coded financial statement visualization in accordance with at least one embodiment of the invention;

FIG. 2 is a block diagram of a exemplary server system for geo-coded financial statement visualization in accordance with at least one embodiment of the invention;

FIG. 3 is a flow chart of an exemplary method of generating geo-coded financial statement in accordance with at least one embodiment of the invention;

FIG. 4 is an exemplary interface illustrating a geo-coded financial statement in accordance with at least one embodiment of the invention;

FIG. 5 is another exemplary interface illustrating a geo-coded financial statement including a transaction detail in accordance with at least one embodiment of the invention; and

FIG. 6 is an exemplary settings screen of an interface for geo-coded financial statement in accordance with at least one embodiment of the invention.

### DETAILED DESCRIPTION

The following description is intended to convey a thorough understanding of the embodiments described by providing a number of specific embodiments and details involving systems and methods for making geo-coded financial statements. It should be appreciated, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

For purposes of this disclosure and claims the term “financial statement” will be interpreted broadly to refer to any financial statement associated with a purchase account including a checking account, debit account, prepaid card account, credit card account, etc.

For purposes of this disclosure and claims the term “geo-coded” will be interpreted broadly to the process of coding an entry such as a purchase transaction to a particular geographic location. The geographic location may be based on a latitudinal and longitudinal coordinate pair at a geographic location of a merchant associated with a particular financial transaction.

For purposes of this disclosure and claims the term “visualization” will be interpreted broadly to refer to a graphic presentation viewed by users via a user interface such as a software client running a computer, personal digital assistant, phone or other computerized communication device.

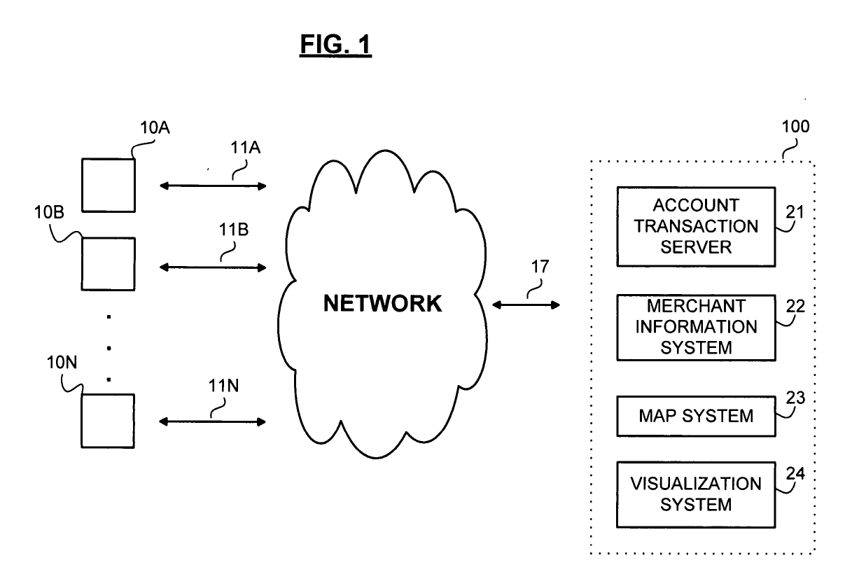

Referring now to FIG. 1, this Figure illustrates a high level block diagram of an exemplary network-based system for geo-coded financial statement visualization in accordance with at least one embodiment of the invention. The network 5 comprises a plurality of user terminals 10A, 10B, . . . , 10N, in communication with a financial account management system 100 via a communication network 15. In various embodiments of the invention, each of the user terminals 10A, 10B, . . . , 10N may comprise a personal computer (PC), a wireless communication device (e.g., phone, personal digital assistant), or other network-enabled device.

Each device 10A, 10B, . . . , 10N may be connected to the network 15 via respective network connections 11A, 11B, . . . , 11N, which, may each comprise a wired connection such as xDSL, cable, T1, T3, dial up. The respective network connections 11A, 11B, . . . , 11N may also comprise one or more wireless connections such as a wireless 802.11x, IrDA, Blue Tooth, or ultra wide band (UWB) that is in connection to a terrestrial access point, router or other device that bridges a wireless connection to a terrestrial connection.

The network 15 may, in various embodiments, comprise a public wide area network (WAN) such as the Internet. The network 15 may also comprise a public switched telephone network (PSTN) or a combination of networks including land-based data networks, land-based voice networks, and/or satellite networks. Also, although the financial account management system 100 is shown as directly connected to the network 15 via connection 17, there may be one or more intermediary networks providing “the last mile” of the connection.

The financial account management system 100 may comprise a financial account transaction server 21, a merchant information system 22, map system 23, and a visualization system 24. The financial account transaction server 21 may comprise a transactional database storing the transactional history of multiple account holders. This server 21 may comprise one or more interfaces for providing account history, such as a web server and related database. The merchant information system 22 may comprise a database of detailed merchant information. The merchant information system 22 may also comprise a connection to one or more external, network-based data services that provides detailed information on merchants beyond the information typically provided in a the transaction clearing network (i.e. merchant name or id, date, financial account number, and transaction amount) The map system 23 may comprise a localized map server that maintains geographic information. The map system 23 may also comprise a link to one or more commercial map content providers that converts street addresses into latitudinal and longitudinal coordinates for display on a map.

The visualization system 24 may comprise one or more programs for taking transaction information from the server 21, and merchant information from the merchant information system 22, identifying merchants associated with various transactions, supplying identification information to the map system 23, determining a coordinate location for each, and generating a map-based statement for account holders that represents transactions for a particular transaction period as a geo-coded statement visualization. In various embodiments, this may comprise outputting the geo-coded statement visualizations to user devices 10A, 11A, . . . , 11N on demand, or at regularly scheduled intervals. The visualization system 23 may generate the geo-coded statements in HTML, JAVA, or some other network browser compatible format for viewing by account holders.

For ease of simplicity, the financial account management system 100 is shown as a integral system surrounded by the dotted line in FIG. 1 which, may imply that the system is located in a single place. It should be appreciated, however, that one or more components of the system 100 may be distributed in different geographical locations thereby forming a virtual system 100.

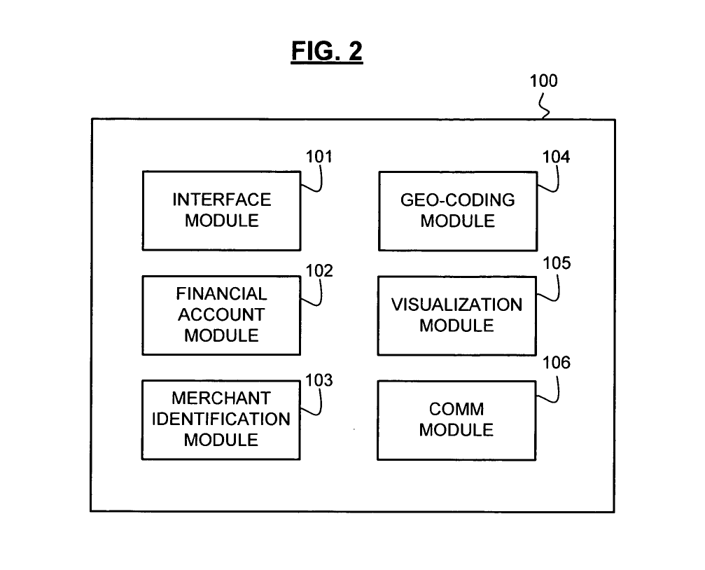

FIG. 2 is a block diagram of a exemplary server system 100 for geo-coded financial statement visualization in accordance with at least one embodiment of the invention. The system 100 comprises various modules which may provide functionality that for creating and outputting geo-coded financial statements to account holders over a communication network. In the example of FIG. 2, an interface module 101, and financial instrument module 102, a merchant identification module 103, a geographic coding module 104, a visualization module 105 and a communications module 106. It should be appreciated that each module may be configured as a software application executing on computer hardware, an application specific integrated circuit (ASIC), a combination of hardware and software, or other suitable configuration. Moreover, one or modules may be combined or broken into multiple additional modules.

The communication module 106, such as, for example, a network interface card, wireless interface card, wireless broadband card, etc., and corresponding device drivers may enable two-way communication between the financial account management system 100 and the plurality of user devices 10A, 10B, . . . , 10N via the network 15 using a packet-based communication protocol or other suitable protocol.

In various embodiments, the interface module 101 may comprise an application program interface (API) for interacting with a software client executing on the user devices 10A, 10B, . . . , 10N. For example, the interface module 101 may comprise a network interface front end, such as a web server front end, for providing security and log in functions.

The financial statement module 102 may comprise a database of financial account transaction information, such as a credit card account database, checking account database, stored-value card database, or other suitable financial account database. Also, the financial statement module 102 may comprise a link or API to such a database that pulls statement information from these systems. This information may be accessed in real time, that is, on demand, or periodically updated in a batch mode, such as daily, hourly, etc.

The merchant identification module 103 may comprise a database of detailed merchant information obtained in part from the financial statement module 102, such as merchant name and/or ID. The merchant identification module 103 may also comprise other information not typically included in an electronic transaction request, such as business address, telephone number, hours of operation, and if applicable, network address. The merchant identification module 103 may maintain this information locally and/or may connect to one or more external data sources to obtain this information, such as, for example, to the Internet, via the communication module 106.

The geo-coding module 104, may comprise a geographic information service, such as a map content provider. The geo-coding module 104 may also comprise a link to a third-party network-based map content provider. For each merchant listed in an account holder's financial account statement, the geo-coding module may determine a set of coordinates such as latitudinal and longitudinal coordinates that can be displayed in a map or other coordinate system-based visualization. In various embodiments, this coordinate information may be stored in the merchant identification module 103 in a data record for that merchant after it has been determined by the geo-coding module 104.

The visualization module 105 may comprise one or more programs that, take a financial statement for a particular time period from the financial statement module 102, obtain for each merchant in the statement detailed merchant information from the merchant identification module 103, and a set of geographic coordinates from the geo-coding module 104, and create a map-based visualization that includes one or more transactions from the time period represented graphically at a map location associated with the merchant. The visualization module 105 may also output the visualization to an account holder via an electronic mail message, or in response to remote command from the account holder to an output device of the account holder, such as devices 10A, 10B, . . . , 10N, in FIG. 1. Also, the visualization module 105 may present a typical electronic statement to a user with a button or other command that when selected causes the statement data to be formatted and sent a third party map content provider so that a geo-coded statement can be created with embedded map points at locations associated with each merchant in the transaction statement. Various third party map content providers operate on the Internet. These content providers typically offer interactive map visualization with standardized functionality including increasing/decreasing map geographic area, zooming in, zooming out, etc.

Each module listed in the system 100 may operate autonomously or under the control a controller, central processing unit (CPU) or control program, such as a real time kernel of a control program of the financial account management system 100. Furthermore, it should be appreciated that the particular modules illustrated in FIG. 2 are exemplary only and should not be construed as either necessary or exhaustive. In various embodiments, it may be desirable to use more, less or even different modules than those illustrated in FIG. 2.

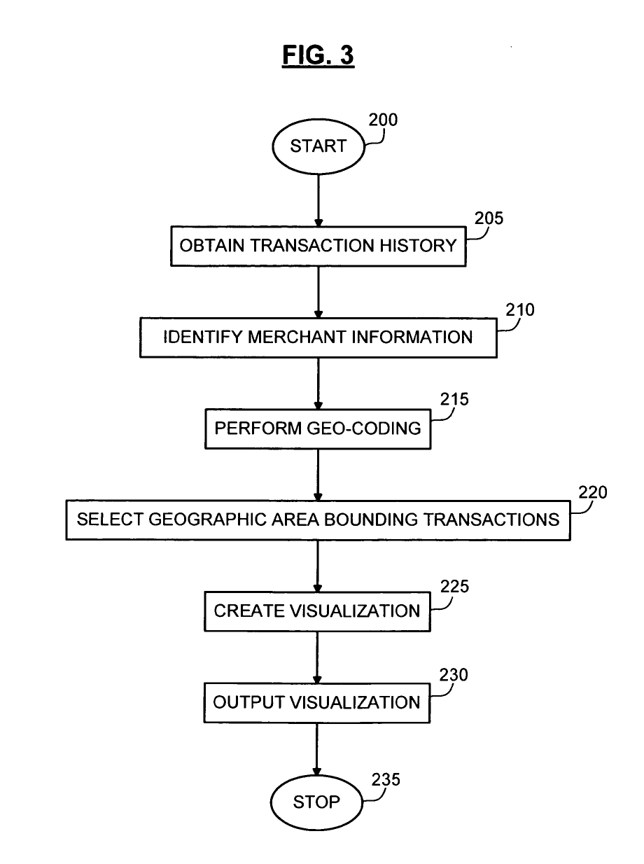

FIG. 3 is a flow chart of an exemplary method of generating geo-coded financial statement in accordance with at least one embodiment of the invention. The method begins in block 200 and proceeds to block 205 where the transaction history for a customer financial account is obtained. This may comprise a customer logging into a website or other network-based system managed by the financial institution affiliated with the account, such as is known in the art. Also, this may comprise a back end process that is transparent to user and done automatically and/or in response to a command for a geo-coded visualization. The transaction information may comprise information from a particular transaction period—a month, quarter, etc.

In block 210 information corresponding to merchants listed in the transactional history may be identified. In various embodiments, the transactional history may contain a list of transactions including a date, dollar amount, and merchant name and/or ID, and account number of the purchaser—information fields typically included in transaction processing networks. In block 210, using this information, more detailed information may identified for each merchant, such as, for example, the merchant's address, hours of operation, telephone number, and if applicable, network address (i.e., Internet website address). Operations performed in block 210 may comprise querying a local database of merchant information. This may also comprise accessing one or more external data sources to obtain this information. In various embodiments, newly acquired merchant information may be stored in a local database to prevent subsequent searches for the same merchant information. In various embodiments, a local process may query the transaction history every N time periods to obtain a list of merchants and then periodically obtain detailed information for those merchants in advance of the statement closing date. In various embodiments, a single field, such as the name, may be used to look up more detailed information in a database of merchant identification information. The database may be integral to the financial account management system 100 or may be part of an external system.

In block 215, the merchant identification information may be used to geo-code transactions from the transactional history. In various embodiments this may comprise obtaining a set of coordinates for each merchant in the transactional history, such as, for example, latitudinal and longitudinal coordinates or x, y and z coordinates. In various embodiments, a table may be temporarily created that contains a listing of each coordinate pair and its associated transactional information. In block 220, a map or geographic area may be selected that bounds some or all of the coordinate pairs. For example, if all transactions occurred within a geographic region bounded by a particular state's borders, a map of the state may be selected. If all the transactions occurred with a geographic region bounded by a particular county's borders, a map of the county may be selected.

In block 225 a visualization is created and in step 230 it is output to an account holder. In various embodiments, the visualization may be created at the server side and output to an account holder's terminal. For example, the visualization may be created in as a document, applet or application that is downloaded to and displayed and/or executed at the client side. Also, the visualization may be generated in HTML, JAVA or other browser-compatible format for display on the user's terminal.

Thus, in operation the method may operate automatically, that is to generate geo-coded statements for users on a periodic basis, such as every statement period. Also, the method may operate on demand, that is in response to a remote account holder request to view a geo-coded financial statement, received over a communication network. Also, the statement may be presented in a conventional format, that is, as an electronic document including a transactional listing for the time period.

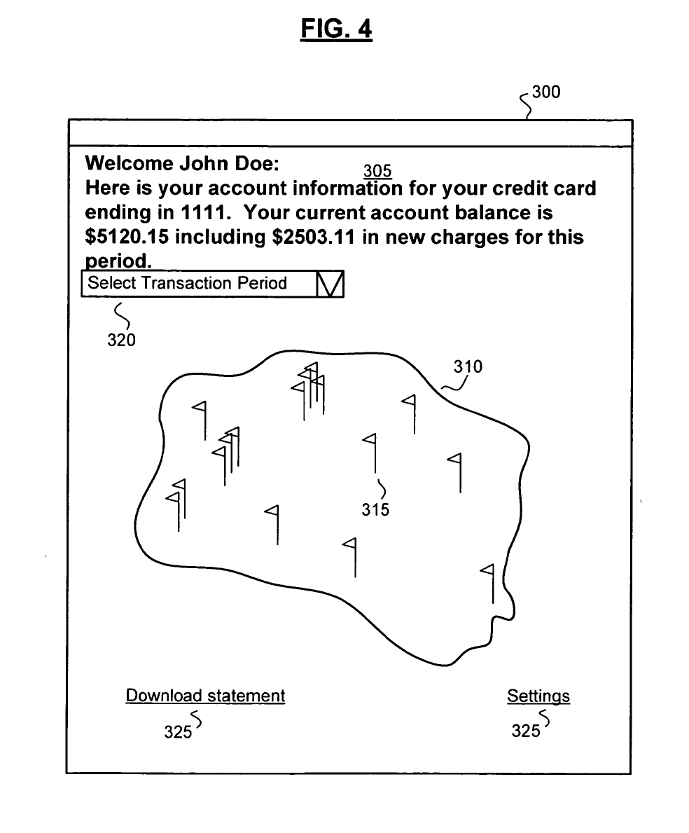

FIG. 4 is an exemplary interface illustrating a geo-coded financial statement in accordance with at least one embodiment of the invention. In various embodiments, the interface 300 may be a window of a local client application running on an account holder terminal such as terminal 10A, 10B, . . . , or 10N of FIG. 1. The client application may be a web browser or other dedicated client application. In various embodiments, interface 300 may be accessed by navigating to a network address associated with the financial institution that maintains the financial account. As is known in the art, the account holder may be required to “log in” or otherwise identify him/herself with credentials in order to prevent access by those other than the account holder.

After authentication, the account holder may be presented with an exemplary visualization such as that of interface 300 in FIG. 4. The interface 300 includes a personalized message portion 305 that identifies the account holder, states the balance for the current period and any previous balance. The interface 300 also includes a map 310 that illustrates a geographic area that, in various embodiments, may encompass all merchants affiliated with transactions included in the account holder's statement for the current statement period. As noted above, this may be a state, county, region or city map, depending upon the breadth of geographic distribution of the account holder's transactions.

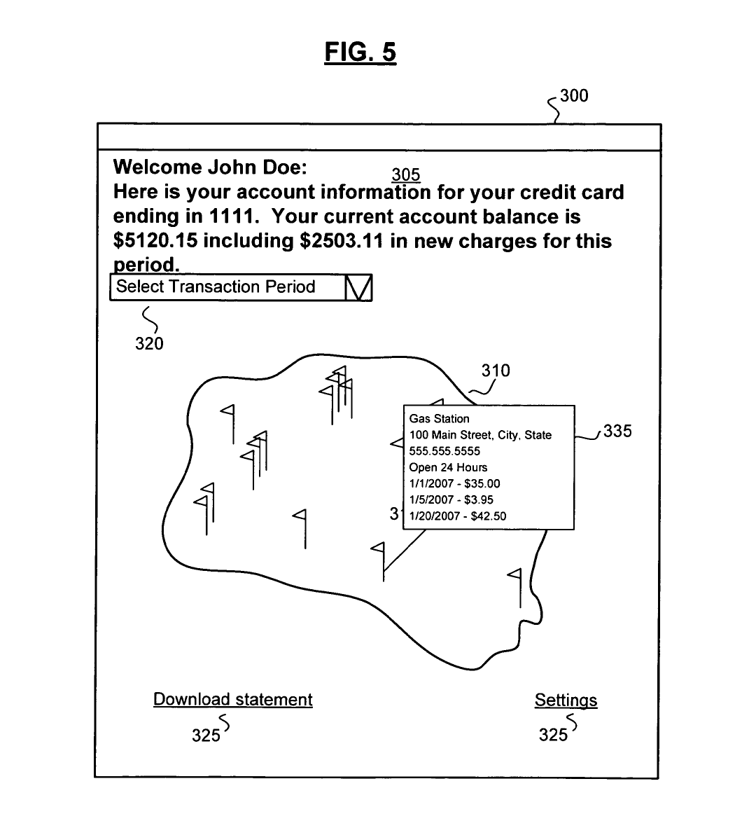

For each transaction in the account holder's statement, the map 310 may include a flag or other graphical icon located on the map at coordinate locations that identify the physical location of the merchant associated with the transaction. As will be discussed in greater detail in the context of FIG. 5, mousing over or clicking on each of the points, flags in the context of FIG. 4, will cause information corresponding to the merchant and/or transaction to appear. The interface 300 may also include a control 320 to select a transaction period such as a drop down list, and a link 325 to download the statement as a file and/or link.

FIG. 5 is another exemplary interface illustrating a geo-coded financial statement including a transaction detail in accordance with at least one embodiment of the invention. In the interface 300 of FIG. 5, a user has selected one of the transactions by clicking on mousing over the map point. In response to this action, a bubble 335 or other pop-up display may appear providing the account holder with detailed information corresponding to that merchant. For example, this information may include the name and address of the merchant, the merchant's telephone number, the merchants hours of operation, and if relevant, a link to the merchant's web site or other network address. If multiple transactions have occurred for a single merchant, these transactions may be listed as multiple entries in a single bubble 335 and/or pop-up window. As discussed here, detailed merchant information may appear such as the merchant's address, hours of business, telephone number, web address or other information. Also, a link to a copy of the transaction statement for that transaction may also appear on the window 335.

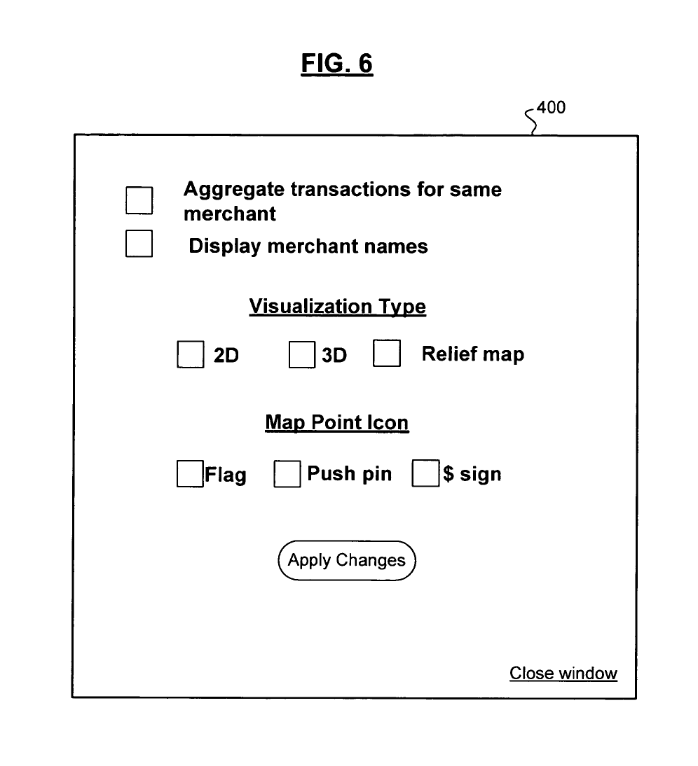

FIG. 6 is an exemplary settings screen of an interface for geo-coded financial statement in accordance with at least one embodiment of the invention. In various embodiments, the interface 400 may appear when a user clicks on or otherwise selects an options or settings link while viewing a geo-coded visualization, such as the link 330 shown in the interface 300 of FIG. 4. The interface 400 may allow a user to change the “look and feel” of the visualization. The interface 400 may allow the user to aggregate transactions for the same merchant so that they appear as a single map point. The interface 400 may also allow a user to select either 2D or 3D visualization, relief or non relief, to change the map point icon, to display merchant names next to the map points. Either radio buttons, check boxes, input fields, interactive controls and or other known control functions may be used.

Thus, the various embodiments of the invention provide an interactive geo-coded visualization interface for viewing financial account statements including transactional history over a communication network. The systems and methods described herein provide advantages over existing systems in that the user experience is enhanced and more data may be simultaneously conveyed to the user than is possible in conventional online statements.

The embodiments of the present inventions are not to be limited in scope by the specific embodiments described herein. For example, although many of the embodiments disclosed herein have been described in the context of systems and methods for generating geo-coded financial account statements, other embodiments, in addition to those described herein, will be apparent to those of ordinary skill in the art from the foregoing description and accompanying drawings. Thus, such modifications are intended to fall within the scope of the following appended claims. Further, although some of the embodiments of the present invention have been described herein in the context of a particular implementation in a particular environment for a particular purpose, those of ordinary skill in the art will recognize that its usefulness is not limited thereto and that the embodiments of the present inventions can be beneficially implemented in any number of environments for any number of purposes. Many modifications to the embodiments described above can be made without departing from the spirit and scope of the invention. Accordingly, the claims set forth below should be construed in view of the full breath and spirit of the embodiments of the present inventions as disclosed herein. Also, while the foregoing description includes many details and specificities, it is to be understood that these have been included for purposes of explanation only, and are not to be interpreted as limitations of the present invention.

1-20. (canceled)

21. A method of preparing a transaction visualization comprising:
receiving, at a server within a financial account management system via a network, a request to generate a geo-coded transaction record, wherein the request comprises a start date, an end date, and at least one financial account selection;
accessing, at the server within the financial account management system, a record of transactions associated with the at least one financial account for a particular time period defined by the start date and the end date, the at least one financial account associated with a customer;
for each transaction in the record of transactions, obtaining identification information comprising a location of the transaction;
generating, using the server within the financial account management system, a geo-coded transaction record based on the identification information for each transaction and a geographic map of a region, the geo-coded transaction record comprising a marker on the geographic map at coordinates associated with the location of the transaction, wherein the marker comprises linking information corresponding to the transaction such that selecting the marker with an input device associated with a user device causes the information corresponding to the transaction to be output to a display at the user device; and
transmitting the geo-coded transaction record to the user device for display on the user device over a network, wherein the geo-coded transaction record as transmitted for display is bounded by the identification information for each transaction.

22. The method according to claim 21, wherein the identification information further comprises a merchant name associated with each transaction.

23. The method according to claim 21, wherein the identification information further comprises a merchant location associated with each transaction.

24. The method according to claim 21, wherein the linking information includes at least one of: merchant data and transaction data.

25. The method according to claim 21, wherein the geo-coded transaction record is further bounded by a transaction period.

26. The method according to claim 21, wherein outputting the geo-coded transaction record to a user over a network comprises generating a computer code-based rendition of the geo-coded transaction record and outputting the computer code-based rendition to a computing device of the user for display.

27. A financial account transaction visualization system comprising:
a processor and an electronic database, the processor operable to execute:
a customer account module storing account information corresponding to a plurality of customers in an electronic database;
a transaction module storing financial transactions associated with the customer accounts in the electronic database, wherein each financial transaction comprises a location of the transaction;
a geo-coding module that:
receives a request to generate a geo-coded transaction record, wherein the request comprises a start date, an end date, and at least one financial account selection; and
utilizes a processor to code each transaction associated with the at least one selected financial account occurring between the start date and the end date to a set of geographical coordinates based on the location of the transaction; and
a visualization module that outputs the geo-coded transaction record based on the request and a geographic map of a region, the geo-coded transaction record comprising a marker on the geographic map at coordinates associated with the location of the transaction, wherein the marker comprises linking information corresponding to the transaction such that selecting the marker with an input device associated with a user device causes the information corresponding to the transaction to be output to a display at the user device, wherein the geo-coded transaction record is bounded by the location of each transaction.

28. The visualization system according to claim 27, wherein the transaction module comprises a credit card transaction server that is operable to receive transactional information corresponding to customer credit card transactions.

29. The visualization system according to claim 28, wherein each financial transaction further comprises of a merchant name, a merchant phone number and a merchant network address.

30. The method according to claim 27, wherein the linking information includes at least one of: merchant data and transaction data.

31. A network-based financial account visualization system comprising:
a processor and an electronic database of transactional history, the processor operable to execute:
a first interface that accesses the electronic database of transactional history for a plurality of customer financial accounts, wherein the transaction history includes a plurality of transactions and each transaction includes a merchant identifier;
a second interface that accesses an electronic database of merchant identification information that stores merchant identification information of merchants associated with transactions in the transactional history, wherein the merchant identification information comprises a merchant location and a merchant identifier;
a geographic mapping module that utilizes a processor to geo-code transactions accessed by the first interface to merchant identification information in map-based visualizations, wherein each transaction of the first interface is linked to a merchant location of the second interface using the corresponding merchant identifier; and
an output module that outputs map-based visualizations in a bounded map over a communications network, wherein the output map-based visualizations are output if the transaction associated with the map-based visualization falls between a user-input start date and a user-input end date and is associated with at least one user-selected financial account, and wherein bounded map is bounded by the identification associated with each of the output map-based visualizations, wherein the map-based visualizations comprise a marker on the geographic map at coordinates associated with the location of the transaction, wherein the marker comprises linking information corresponding to the transaction such that selecting the marker with an input device associated with a user device causes the information corresponding to the transaction to be output to a display at the user device.

32. The system according to claim 31, wherein the database of transaction history comprises a credit card transaction database.

33. The system according to claim 31, wherein the merchant identification information further comprises a merchant name.

34. The system according to claim 31, wherein the wherein the merchant identification information further comprises a merchant address.

35. The system according to claim 31, wherein the wherein the merchant identification information further comprises a merchant telephone number.

36. The system according to claim 31, wherein the geographic mapping module is operable to generate geo-coded transaction statements for account holders that include a geographic map containing map points at coordinate locations associated with each merchant included in the transaction history for a predetermined period of activity.

37. The system according to claim 31, wherein the linking information includes at least one of: merchant data and transaction data.

38. The system according to claim 37, wherein the geo-coded transaction record is further bounded by a transaction period.

39. The system according to claim 37, wherein the first interface is operable to receive transactional information corresponding to customer credit card transactions.

40. The system according to claim 31, wherein the output module comprises an Internet web server adapted to output map-based visualizations in a web browser-compliant format to remote user devices over the Internet.
